(19) United States
(12) Patent Application Publication
(10) Pub. No.: US 2007/0159296 A1
(43) Pub. Date: Jul. 12, 2007

(54) RF-mode temporary door-lock opening method and device in home network environments

(75) Inventors: Jae-gap Lee, Seoul (KR); Dong-yun Hwang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/500,409

(22) Filed: Aug. 8, 2006

(30) Foreign Application Priority Data
Jan. 2, 2006 (KR) 10-2006-0000132

(51) Int. Cl. H04L 9/32

(52) U.S. Cl. 340/5.23; 340/5.61

(57) ABSTRACT

A radio frequency (RF)-mode temporary opening method and device in home network environments. The RF-mode temporary door lock opening method includes transmitting to a communication terminal an access allowance confirmation message and information on an access card to be temporarily issued; receiving an access allowance approval message from the communication terminal; and transmitting to a home gateway the information on the access card in order to register in a door lock the information on the access card.

### CROSS-REFERENCE TO RELATED APPLICATIONS

This application claims priority from Korean Patent Application No. 10-2006-0000132, filed Jan. 2, 2006 in the Korean Intellectual Property Office, the entire contents of which are incorporated herein by reference.

### BACKGROUND OF THE INVENTION

1. Field of the Invention

The present invention relates to an radio frequency (RF)-mode temporary door-lock opening method and device, and more particularly, to an RF-mode temporary door-lock opening method and device in home network environments for temporarily opening a door lock to provide access to users not having an RF card for opening the door-lock.

2. Description of the Related Art

It is a recent trend that appliances such as an Internet refrigerator, video and audio systems, and the like are connected to one network together with digital television sets to form a home network. Further, in addition to home appliances, communication media, security media, and the like become integrated, and thus a home network is gradually of practical use which enables integral management through data communications on a network. That is, the home network realizes information sharing and home automation through a network within a home.

Security concerns have increased the need for a method for realizing automatic opening of a door lock, which is an example of a security medium, through a network even in such home network environments, for example, a method for safely opening a door lock in case a visitor comes by when no one is home or when a family member returns home without an access card for opening the door lock.

However, in related art simple door-lock opening methods which are not realized under home network environments, only users having an access card can open a door lock. That is, a visitor who does not have an access card cannot access make access, and can make access only if accompanied by a resident who has the access card. Further, in the case a door-lock is opened by using an access card or a password, the user can make access only when he or she knows the password if they do not have the access card.

Thus, a person cannot make access if he or she does not have an access card or does not know a password. Furthermore, a door-lock asking for a password input has a drawback in that it has security weakness as well as increases its volume.

Another related art network-associated door lock opening method enables a resident to remotely control and open a door lock by a mobile communication terminal outside his or her home. However, since this also asks for authentication of a mobile communication terminal, there exists security weakness when the mobile communication terminal is lost.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an RF-mode temporary door lock opening method and device in home network environments.

The present invention also provides an temporary door lock opening method and device using only an RF mode access card to reduce the volume of a door lock.

The present invention also provides an RF-mode temporary door lock opening method and device in home network environments to make up for security weakness.

According to an aspect of the present invention, there is provided a door lock opening method, comprising: a home gateway for receiving an access card number to be temporarily issued and registering information on the received access card to be temporarily issued into a door lock; and a door lock opening device for sending a mobile communication terminal an access allowance confirmation message and information on an access card to be temporarily issued that is included in access card information, and sending the home gateway the information on the access card to be temporarily issued in order for the information on the access card to be temporarily issued into the door lock if the access allowance approval is received from the mobile communication terminal.

Further, the access card information may contain at least any one of management number information, card identification (ID) information, address information, home gateway ID, information on a type of use, and resident contact information.

Further, the information on the access card to be temporarily issued may be card ID information and information on a type of use.

The method may further comprise deleting the information on the temporarily issued access card registered in the door lock, if the temporarily issued access card is confirmed to have been returned.

The method may further comprise sending the home gateway the number of times of temporary accesses if the number of times of temporary accesses is received from the mobile communication terminal, wherein, if the number of times of temporary accesses is not received, a default value is sent to the home gateway.

According to another aspect of the present invention, there is provided an RF-mode door lock opening device, comprising a communication interface unit for providing communication interfaces with a mobile communication terminal and a home gateway; a storage unit for storing information on access cards; and a control unit for sending the mobile communication terminal an access allowance confirmation message and information on an access card to be temporarily issued that is included in access card information, and sending the home gateway the information on the access card to be temporarily issued in order for the information on the access card to be temporarily issued to be registered into a door lock.

Further, the access card information may contain at least any one of management number information, card ID information, address information, home gateway ID, information on a type of use, and resident contact information.

Further, the information on the access card to be temporarily issued may be card ID information and information on a type of use.

Further, the control unit may delete the information on the temporarily issued access card registered in the door lock, if the temporarily issued access card is confirmed to have been returned.

The control unit may delete the information on the temporarily issued access card registered in the door lock, if the temporarily issued access card is confirmed to have been returned.

According to another aspect of the present invention, there is provided a door lock opening system, comprising a home gateway for receiving an access card number to be temporarily issued and registering information on the received access card to be temporarily issued into a door lock; and a door lock opening device for sending a mobile communication terminal an access allowance confirmation message and information on an access card to be temporarily issued that is included in access card information, and sending the home gateway the information on the access card to be temporarily issued in order for the information on the access card to be temporarily issued into the door lock if the access allowance approval is received from the mobile communication terminal.

Further, the mobile communication terminal may send the home gateway the information on the access card to be temporarily issued without passing through the door lock opening device.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a view illustrating a door lock opening system including a door lock opening device in home network environments according to an exemplary embodiment of the present invention;

FIG. 2 is a block diagram illustrating the door lock opening device according to an exemplary embodiment of the present invention; and

FIG. 3 is a flow chart illustrating a door lock opening method for a door lock opening device according to an exemplary embodiment of the present invention.

### DETAILED DESCRIPTION OF THE EXEMPLARY EMBODIMENTS

Hereinafter, the exemplary embodiments of the present invention will be described in detail with reference to the accompanying drawings.

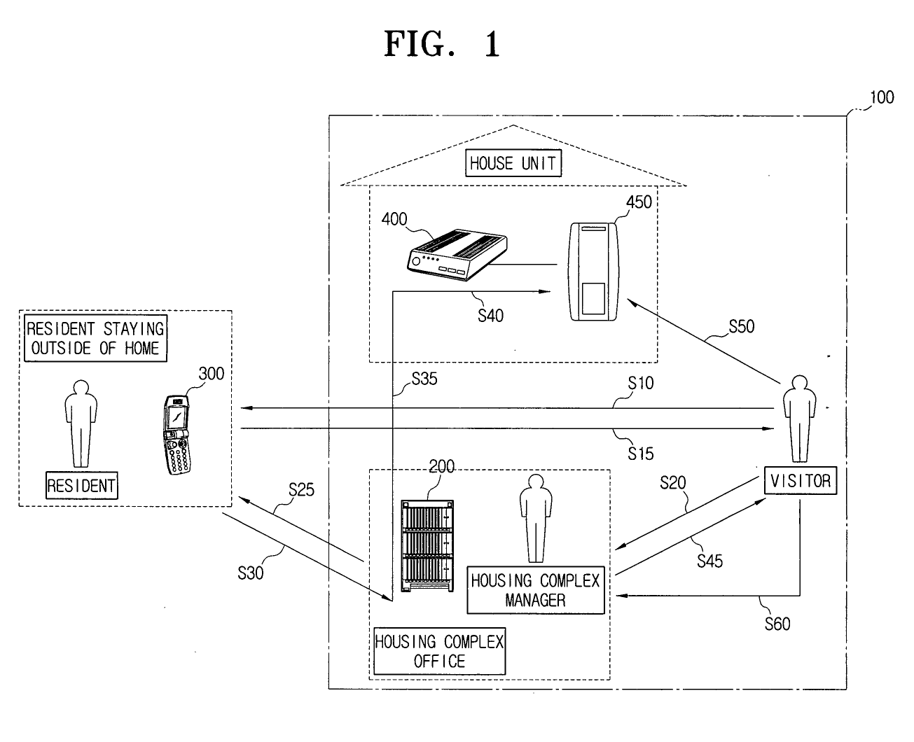

FIG. 1 is a view illustrating a door lock opening system including a door lock opening device in home network environments according to an exemplary embodiment of the present invention.

In FIG. 1, a door lock opening system 100 in home network environments is capable of opening a door locks 450 of each housing unit located within a housing complex, which includes a housing complex server 200, home gateways 400, and door locks 450.

The housing complex server 200 is a server located at a management office within the complex, i.e., a management office, which is an example of a door lock opening device for temporarily opening a door lock 450 of a housing unit to provide a temporary visitor access to the housing unit. In detail, the housing complex server 200 receives an access allowance approval for a temporary visitor from a resident outside of the housing unit, and temporarily opens the door lock 450.

The mobile communication terminal 300 is an intermediate medium for temporarily approving the opening of the door lock 450, which receives an access allowance confirmation request for the temporary visitor from the housing complex server 200. Further, the mobile communication terminal 300 can provide an interface for access allowance approvals and a number of access times setting. If the resident confirming the request approves the access allowance and sets the number of access times, the mobile communication terminal 300 sends the access allowance and the number of access times for the door lock 450 to the housing complex server 200. The mobile communication terminal 300 may communicate with the housing complex server 200 according to the wireless application protocol (WAP).

The home gateway 400 communicates with the housing complex server 200, and controls the temporary opening of the door lock 450. In detail, the home gateway 400 receives the access allowance approval and a temporary access card number from the housing complex server 200, and controls the opening of the door lock 450 if the received temporary access card number is recognized. The home gateway 400 communicates with the housing complex server 200 through Local Area Network (LAN) or Internet, and communicates with the door lock 450 through wired or wireless interfaces, such as power line communication (PLC), IEEE 1394, home RF, Bluetooth, and so on. Further, the door lock 450 communicates with the access card in an RF mode. The RF mode is a communication mode through the sensing of an RF chip rather than the direct contact of the access card.

Hereinafter, description will be made on a method of the temporary opening of the door-lock 450 of the door lock opening system 100 in home network environments shown in FIG. 1.

A visitor without an access card requests access through the mobile communication terminal 300 of a resident located outside the housing unit (S10), and receives access allowance from the resident (S15). Next, the access-allowed visitor requests a complex manager for a temporary access card (S20).

The housing complex server 200 sends the resident a message confirming the access allowance and a temporary access card number to be issued through the mobile communication terminal 300 (S25). Therefore, if an access allowance approval message is received from the resident through the mobile communication terminal 300 (S30), the complex server 200 sends the home gateway 400 the temporary access card number to be issued (S35). Next, the home gateway 400 sends the door lock 450 the received temporary access card number (S40).

The housing complex manager issues a temporary access card to the visitor (S45), and the visitor places the issued temporary access card over the door lock 450 (S50). The door lock 450 opens if the recognized access card number matches the received temporary access card number.

Further, if the visitor returns the issued temporary access card (S60), the housing complex server 200 has the home gateway 400 de-register/invalidate the returned temporary access card number, and the home gateway 400 has the door lock 450 de-register/invalidate the returned temporary access card number.

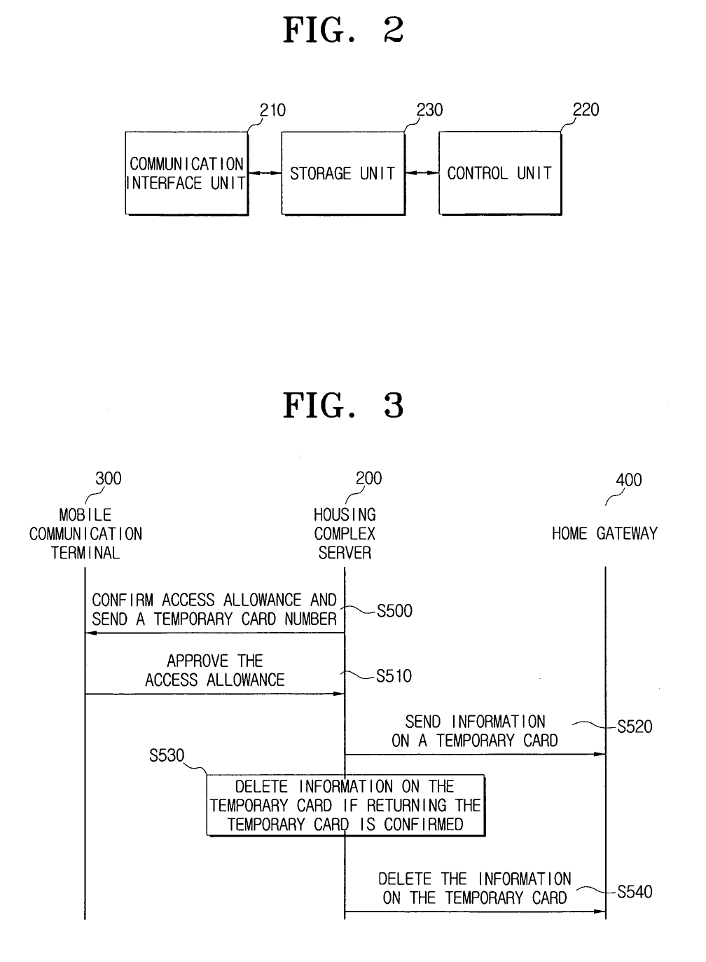

FIG. 2 is a block diagram illustrating a door lock opening device according to an exemplary embodiment of the present invention.

In FIG. 2, the housing complex server 200, being an example of the door lock opening device, manages idle access cards of the housing complex, and includes a communication interface unit 210, a storage unit 220, and a control unit 230.

The communication interface unit 210 provides interfaces for communicating with the mobile communication terminal 300 of a resident and for communicating with the home gateway 400.

The storage unit 220 stores the information on all of the access cards of the housing complex. Table 1 shows an example of the information on all the access cards of the housing complex stored in the storage unit 220.

TABLE 1

| | | | | | Contact |
|---|---|---|---|---|---|
| Management | | Address | Home gateway | Types of | Information of |
| Numbers | Card IDs | Information | IDs | use | residents |
| 10001 | 000c0001 | Block 101, | 101.xxx | Family | xx-xxx-xxxx |
| | | unit 101 | | | |
| 10002 | 000c0002 | Block 101, | 101.xxx | Family | xx-xxx-xxxx |
| | | unit 101 | | | |
| 10003 | 000c0003 | Block 101, | 101.xxx | Family | xx-xxx-xxxx |
| | | unit 101 | | | |
| 10004 | 000c0004 | Block 101, | 101.xxx | Temporarily | xxx-xxx-xxxx |
| | | unit 101 | | issued | |
| 10005 | 000c0005 | Block 102, | 102.xxx | Family | xx-xxx-xxxx |
| | | unit 102 | | | |

As shown in Table 1, the access card information is the information on the previously issued cards and the temporarily issued cards, and contains the information on the management number given to each access card, card identification (ID) information, address information, home gateway ID, information on the type of use, and contact information of a resident. The management number is a number that a user can recognize, the card ID is an ID that a door lock 450 can recognize, and the address information, home gateway ID, information on the type of use, and contact information of a resident are the information on the house unit given an access card. As a practical matter, the temporary access card number sent to the home gateway 400 is a card ID. In here, it can be seen that the access card of management number 10004 is temporarily issued to a visitor to the unit 101 of the block 101.

The control unit 230 manages all the access cards of the housing complex using the access card information stored in the storage unit 220. As an example, description will be made under assumption that there is a visitor to the unit 101 of the block 101.

In detail, the control unit 230 sends an access allowance confirmation message and an access card number to be temporarily issued, i.e., a management number 10004, to the mobile communication terminal 300 corresponding to the contact information xxx-xxx-xxxx of a resident living in the unit 101 of the block 101 through the communication interface unit 210. If the access allowance approval is received from the mobile communication terminal 300, the control unit 230 sends through the communication interface unit 210 a access card ID 000c0004 to be temporarily issued and the type of use to the home gateway 400 corresponding to the home gateway ID 101.xxx of the unit to be visited. In here, if the number of access times is not received from the mobile communication terminal 300, the control unit 230 sends the home gateway 400 a default value of one time as the number of access times.

Further, if the temporarily issued access card is returned, the control unit 230 deletes the information on the temporarily issued access card from the access card information stored in the storage unit 220. Moreover, the control unit 230 can request the home gateway 400 to delete the card ID 000c0004 and the type of use of the temporarily issued access card.

FIG. 3 is a flow chart illustrating a temporary door lock opening method for a door lock opening device according to an exemplary embodiment of the present invention.

In FIG. 3, the housing complex server 200 sends the mobile communication terminal 300 an access allowance confirmation message and the number of an access card to be temporarily issued, i.e., the card ID information (S500).

If an access allowance approval is received from the mobile communication terminal 300 (S510), the housing complex server 300 sends the home gateway 400 the information on the access card to be temporarily issued for registration (S520). The information on the access card to be temporarily issued contains the card ID information and the type of use information.

Then, if the return of the temporarily issued access card is confirmed, the housing complex server 200 deletes the stored temporary access card information (S530). Further, the housing complex server 200 sends a message to the home gateway 400 to have the temporary access card information de-registered in the home gateway 400 and the mobile communication terminal 300 (S540).

As stated above, it is shown and described that the access allowance approval and the information on the access card to be temporarily issued are sent to the home gateway 400 through the housing complex server 200, which is merely exemplary, and it can be realized that the access allowance approval and the information on the access card to be temporarily issued can be directly sent from the mobile communication terminal 300 to the home gateway 400.

As described above, the present invention reduces the volume of a door lock as well as makes up for the weakness of security due to double authentication.

As aforementioned, the exemplary embodiments of the present invention are shown and described, but the present invention is not limited to the specific exemplary embodiments described above, and can be implemented in various modifications by those skilled in the art to which the present invention pertains without departing the scope of the present invention claimed in the appended claim.

What is claimed is:

1. A radio frequency (RF)-mode temporary door lock opening method comprising:
transmitting to a communication terminal an access allowance confirmation message and information on an access card to be temporarily issued;
receiving an access allowance approval message from the communication terminal in response to the access allowance confirmation message; and
transmitting to a home gateway the information on the access card in order to register in a door lock the information on the access card.

2. The method as claimed in claim 1, wherein the information on the access card comprises card identification (ID) information and information on a type of use.

3. The method as claimed in claim 2, further comprising storing access card information, wherein the access card information comprises the card ID information and the information on the type of use.

4. The method as claimed in claim 3, wherein the access card information further comprises at least one of management number information, address information, home gateway ID information, and resident contact information.

5. The method as claimed in claim 3 further comprising deleting the card ID information and the information on the type of use, if the access card is confirmed to have been returned.

6. The method as claimed in claim 1 further comprising sending the home gateway a number of times of temporary accesses of the access card if the number of times of temporary accesses of the access card is received from the communication terminal, wherein, if the number of times of temporary accesses of the access card is not received, a default number of times of temporary accesses of the access card is sent to the home gateway.

7. The method as claimed in claim 1 further comprising transmitting a message to the home gateway in order to de-register in the door lock the information on the access card if the access card is confirmed to have been returned.

8. A radio-frequency (RF)-mode door lock opening device comprising:
a control unit which transmits to a communication terminal an access allowance confirmation message and information on an access card to be temporarily issued, and transmits to a home gateway the information on the access card in order to register in a door lock the information on the access card.

9. The device as claimed in claim 8, wherein the information on the access card comprises card identification (ID) information and information on a type of use.

10. The device as claimed in claim 9 further comprising a storage unit which stores access card information under control of the control unit, wherein the access card information comprises the card ID information and the information on a type of use.

11. The device as claimed in claim 10, wherein the access card information further comprises at least one of management number information, address information, home gateway ID information, and resident contact information.

12. The device as claimed in claim 10, wherein the control unit deletes the stored information on the access card stored in the storage unit if the access card is confirmed to have been returned.

13. The device as claimed in claim 8 further comprising a communication interface unit which provides communication interfaces through which the control unit communicates with the communication terminal and the home gateway.

14. The device as claimed in claim 8, wherein the control unit transmits to the home gateway a number of times of temporary accesses of the access card if the number of times of temporary accesses of the access card is received from the communication terminal, and, if the number of times of temporary accesses of the access card is not received, transmits to the home gateway a default number of times of temporary accesses of the access card.

15. The device as claimed in claim 8, wherein the control unit transmits a message to the home gateway in order to de-register in the door lock the information on the access card if the access card is confirmed to have been returned.

16. A door lock opening system comprising:
a home gateway which receives information on an access card to be temporarily issued, and registers the information on the access card in a door lock; and
a door lock opening device which transmits to a communication terminal an access allowance confirmation message and the information on the access card, and transmits to the home gateway the information on the access card if an access allowance approval message is received from the communication terminal.

17. The system as claimed in claim 16, wherein the communication terminal transmits the information on the access card directly to the home gateway.

18. The system as claimed in claim 16, wherein the information on the access card comprises card identification information and information on a type of use.

19. The system as claimed in claim 18, wherein the door lock opening device stores the information on the access card.

20. The system as claimed in claim 16, wherein the door lock opening device transmits to the home gateway a number of times of temporary accesses of the access card if the number of times of temporary accesses of the access card is received from the communication terminal, and, if the number of times of temporary accesses of the access card is not received, transmits to the home gateway a default number of times of temporary accesses of the access card.

21. The system as claimed in claim 19, wherein the door lock opening device deletes the stored information on the access card if the access card is confirmed to have been returned.

22. The system as claimed in claim 16, wherein the door lock opening device transmits a message to the home gateway in order to de-register in the door lock the information on the access card if the access card is confirmed to have been returned.
